(19) United States
(12) Patent Application Publication
(10) Pub. No.: US 2018/0101863 A1
(43) Pub. Date: Apr. 12, 2018

(54) ONLINE CAMPAIGN MEASUREMENT ACROSS MULTIPLE THIRD-PARTY SYSTEMS

(71) Applicant: Facebook, Inc., Menlo Park, CA (US)

(72) Inventors: Aleksey Sergeyevich Fadeev, Seattle, WA (US); Liang Xu, Bellevue, WA (US)

(21) Appl. No.: 15/288,760

(22) Filed: Oct. 7, 2016

(51) Int. Cl. G06Q 30/02; G06N 99/00; G06Q 10/06

(52) U.S. Cl. CPC G06Q 30/0248; G06Q 10/067; G06Q 30/0246; G06N 99/005

(57) ABSTRACT

Disclosed is an online system providing a fair measurement platform for people-based measurement of performance of an online campaign across different third-party systems that eliminates bias for certain third-party systems. The online system determines the measurable portion of the online campaign, where this is a portion of the campaign for which the online system knows the identities of the users and the online system knows that the impressions were viewable. The online system extrapolates with a model out from the measurable portion of the campaign to provide a broader measurement for the campaign including impressions for which identify coverage is incomplete and for which viewability is not available to provide a full, unbiased measurement for the online campaign across various third-party systems, regardless of whether they account for viewability, have identity coverage, or detect fraud.

### BACKGROUND

This disclosure relates generally to online systems, and more specifically to people-based measurement of an online campaign across multiple third-party systems by an online system.

Online systems, such as social networking systems, allow users to connect and communicate with other online system users. Online systems present content items to users based on one or more targeting criteria determined considering the anticipated reach to its users. The providers of such content items expect these online systems to provide a high quality measurement of the frequency and reach and/or outcome of the users interacting with the content items.

Conventionally, each online system may report the performance of a content item on that online system to the providers, and this reporting factors in that online system's own capability detect fraudulent activities on the online system so these are not reported as events, to recognize user interactions that are viewable to the online system, and to recognize users that are well-known to the online system. The performance report generated by each online system may have a bias towards events that this particular online system can recognize more readily that other online systems. For example, fraudulent activities associated with a content item that are not real actions taken by real users on the content item should not be included in a report on the performance of the content item. However, some online systems may be able to detect fraudulent events more readily than others, resulting in biased reporting that favors systems less adept at detecting fraud since these systems are reporting more interactions with content items and hence more success (even though, unbeknownst to the parties, a portion of the interactions reported were actually fraudulent).

Such biased reporting on the performance of the content items from the providers presenting to the users limits the accuracy of the performance measurement. Thus, the providers of the content items might overspend on an online campaign with one online system due to not having an accurate method of measuring the performance of the online campaign across multiple online systems with which users are associated.

### SUMMARY

An online system, such as a social networking system, provides a fair measurement platform to provide people-based measurement of performance of an online campaign across content publishers, including the online system itself along with different third-party systems. This eliminates bias for certain systems over others due to various factors, such as ability to more readily detect fraud in reporting performance data, to account for viewability of the ad in reporting, to determine identity of users interacting with ads, etc. The online system provides impressions for a campaign to users, and determines a measurable portion of the campaign, where this is the portion of the campaign for which the online system knows identities of the users who had the impressions and also knows that the impressions were viewable by one or more users. The online system then excludes the fraudulent events and extrapolates with a model the results of the measurable portion of the campaign out across portions of the campaign where viewability information is not available and identity coverage is incomplete to provide a broader estimate of performance for the campaign that includes impressions for which identity coverage is incomplete and for which viewability information is not available. This provides a full, unbiased measurement for the campaign as a whole across various third-party systems, regardless of whether they account for viewability, have identity coverage, or detect fraud.

An online system performs tracking operations on an online campaign from third-party systems. The online system performs the tracking operations of online events based on the actions of the users. For example, the tracked online events can represent a click-through, impression, etc.

The online system detects and removes fraudulent events to create non-fraudulent events. A fraudulent event may represent an event declared invalid for the third-party system in a measured campaign. The online system determines the non-measurable events by detecting non-viewable events, and non-identifiable events from the campaign. A non-viewable event may correspond to web pages visited by the users of the online system in an accidental fashion (e.g., bounced page visit), an event in which the content item not actually viewable by the user (e.g., the content item was in a non-viewable location, such below the fold on a web page), or to events where viewability is unknown or knowledge of viewability is incomplete. A non-identifiable event may correspond to an event that has imperfect coverage of identity of users (e.g., the system may be unable to determine the identity of certain users who caused events, such as the identity of users who are not logged into the system when the events associated with the content item occurred). The online system determines the non-measurable events based on a number of click-throughs and an average click-through rate associated with some of the users.

The online system removes the detected non-measurable events from the tracked events to obtain a set of measurable events. The online system performs a modeling on some of the set of measurable events to generate models that represent a subset of the portion of the measurable events used for the modeling. The online system determines the set of measurable events based on a number of tracking conversions and a number of click-throughs associated with the tracked events, with the non-measurable events removed.

The online system performs a modeling on some of the set of measurable events to generate models representing a subset of the set of measurable events. The online system extrapolates the set of measurable events using the generated models to determine a number of valid events.

### BRIEF DESCRIPTION OF THE DRAWINGS

FIG. 1 is a system environment in which an online system operates, in accordance with an embodiment.

FIG. 2 is a block diagram of the online system of FIG. 1, in accordance with an embodiment.

FIG. 3 is a process for a measurement of a online campaign across multiple third-party systems, in accordance with an embodiment.

FIG. 4 is a conceptual diagram of a modeling performed during the measurement of FIG. 3, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Environment

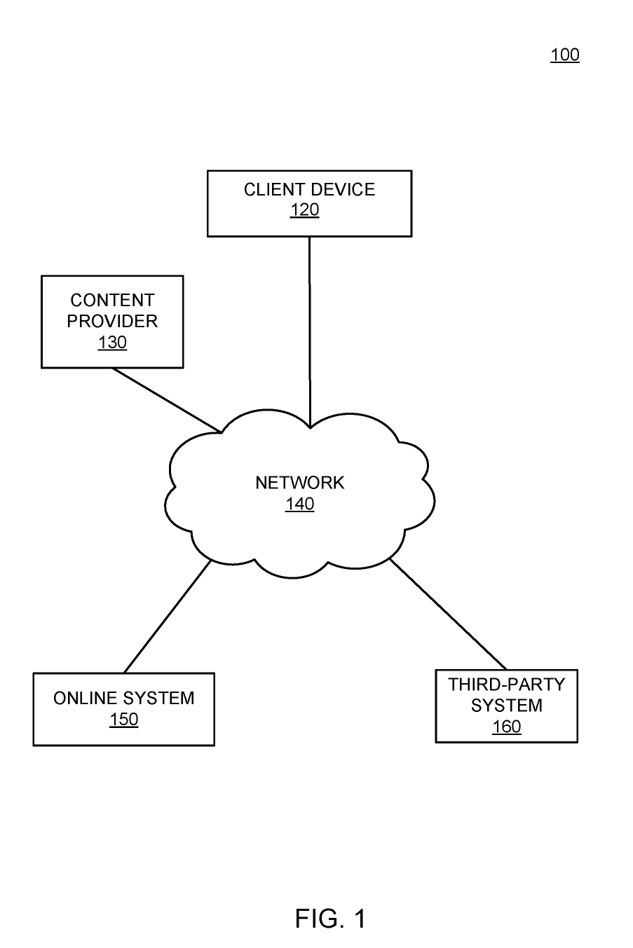

FIG. 1 is a system environment 100 in which an online system 150 operates, in accordance with an embodiment. The system environment 100 shown by FIG. 1 comprises one or more client devices 120, one or more content providers 130, a network 140, the online system 150, and one or more third-party systems 160. In alternative configurations, different and/or additional components may be included in the system environment 100. The embodiments described herein may be adapted to online systems that are not social networking systems.

The client devices 120 are one or more computing devices capable of receiving user input as well as transmitting and/or receiving data via the network 140. In one embodiment, the client device 120 is a conventional computer system, such as a desktop or a laptop computer. Alternatively, the client device 120 may be a device having computer functionality, such as a personal digital assistant (PDA), a mobile telephone, a smartphone or another suitable device. The client device 120 is configured to communicate via the network 140. In one embodiment, the client device 120 executes an application allowing a user of the client device 120 to interact with the online system 150. For example, the client device 120 executes a browser application to enable interaction between the client device 120 and the online system 150 via the network 140. In another embodiment, the client device 120 interacts with the online system 150 through an application programming interface (API) running on a native operating system of the client device 120, such as IOS® or ANDROID™.

The content provider 130 is a system used by content providers for interacting with the online system 160, for example, for providing content and information related to the content. Content provided by the content provider 130 includes video content, audio content, text, or any other type of content. The content may be sponsored content. The content provider 130 may use the online system 150 to host their content and let users access the content. In an embodiment, the content provider 130 interacts with the online system 150 using application programming interfaces (APIs) of the online system 150. The content provider 130 includes a client application that allows users of the client device 120 associated with the content provider 130 to interact with the online system 150.

The interactions between the client devices 120 or content provider 130 and the online system 150 are typically performed via a network 140, for example, via the Internet. The network 140 enables communications between the client device 120 and the online system 150. In one embodiment, the network uses standard communications technologies and/or protocols. The data exchanged over the network can be represented using technologies and/or formats including the hypertext markup language (HTML), the extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc. In another embodiment, the entities can use custom and/or dedicated data communications technologies instead of, or in addition to, the ones described above. Depending upon the embodiment, the network 140 can also include links to other networks such as the Internet.

The online system 150 may perform tracking operations based on the communication received from the client device 120 and the content provider 130 through the network 140. The online system 150 may perform a measurement associated with the users and related to the content items received from the content provider 130 through the network 140. For example, the measurement may be a people-based measurement of demographic attributes and number of users of the online system 150 that click on a content item presented by the content provider 130.

The online system 150 may receive information describing locations of users of the online system 150 from client devices 120 associated with the users. Location information describing locations of the users include geographic coordinates, place identifiers (e.g., store name, street address, etc.), or other information suitable for identifying a physical location. Location information may also include various attributes of the locations, such as types of connections to a network (e.g., BLUETOOTH®, 802.11, global positioning system, etc.) available from a location, identifiers of wireless access points within a threshold distance of the location, identifiers of cellular phone towers within a threshold distance of the location, or other suitable information. For example, location information describing a client device location includes a type of network connection available at the location for transmitting information from the client device 120 to the online system 150.

The third-party system 160 coupled to the network 140 represents another online system not associated with the online system 150. In some embodiments, the third-party systems 160 represent one or more publishing systems that can communicate with the client device 120. The online system 150 interacts with the third-party system 160 through the network 140 to perform a measurement of users responding to the content items provided by the content provider 130. In other embodiments, the third-party systems 160 provide content or other information for presentation via the client device 120. In a different embodiment, the third-party system 160 includes at least some of the content providers 130.

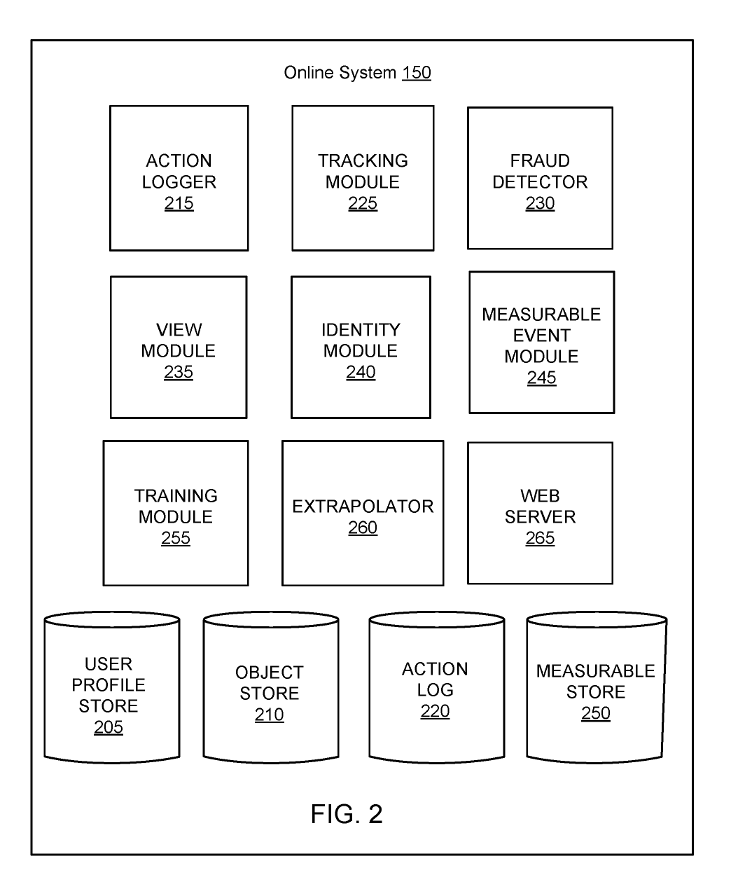

FIG. 2 is a block diagram of the online system 150 of FIG. 1, in accordance with an embodiment. The online system 150 includes a user profile store 205, an object store 210, an action logger 215, an action log 220, a tracking module 225, a fraud detector 230, a view module 235, an identity module 240, a measurable event module 245, a measurable store 250, a training module 255, an extrapolator 260, and a web server 265. In other embodiments, the online system 150 may include additional, fewer, or different components for various applications. For example, in one embodiment, each of the user profile store 205, object store 210, and measurable store 250, could be in a single store. Conventional components such as network interfaces, security functions, load balancers, failover servers, management and network operations consoles, and the like are not shown so as to not obscure the details of the system architecture.

Each user of the online system 150 is associated with a user profile, which is stored in the user profile store 205. A user profile includes declarative information about the user that was explicitly shared by the user and may also include profile information inferred by the online system 150. A user profile may also store other information provided by the user, for example, images or videos. In certain embodiments, images of users may be tagged with information identifying the online system users displayed in an image. A user profile in the user profile store 205 may also maintain references to actions by the corresponding user performed on content items in the object store 210 and stored in the action log 220.

The object store 210 stores objects that each represent various types of content. Examples of content represented by an object include a page post, a status update, a photograph, a video, a link, a shared content item, a gaming application achievement, a check-in event at a local business, a page (e.g., brand page), an advertisement, or any other type of content. Online system users may create objects stored by the object store 210, such as status updates, photos tagged by users to be associated with other objects in the online system 150, events, groups or applications.

The action logger 215 receives communications about user actions internal to and/or external to the online system 150, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the online system 150 to track user actions on the online system 150, as well as actions on the third-party system 160 that communicate information to the online system 150. Users may interact with various objects on the online system 150, and information describing these interactions is stored in the action log 220. Examples of interactions with objects include: commenting on posts, sharing links, checking-in to physical locations via a mobile device, accessing content items, and any other suitable interactions. Additional examples of interactions with objects on the online system 150 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 150 as well as with other applications operating on the online system 150. In some embodiments, data from the action log 220 is used to infer interests or preferences of a user, augmenting the interests included in the user's user profile and allowing a more complete understanding of user preferences.

The action log 220 may also store user actions taken on the one or more third-party systems 160, such as an external website, and communicated to the online system 150. For example, an e-commerce website may recognize a user of the online system 150 through a social plug-in enabling the e-commerce website to identify the user of the online system 150. Because users of the online system 150 are uniquely identifiable, e-commerce websites, such as in the preceding example, may communicate information about a user's actions outside of the online system 150 to the online system 150 for association with the user. Hence, the action log 220 may record information about actions users perform on the third-party system 160, including webpage viewing histories, advertisements that were engaged, purchases made, and other patterns from shopping and buying. Additionally, actions a user performs via an application associated with the third-party system 160 and executing on the client device 120 may be communicated to the action logger 215 for storing in the action log 220 by the application for recordation and association with the user by the online system 150.

The tracking module 225 performs tracking operations on an online campaign in the online system 150 from one or more third-party systems 160. The tracking module 225 performs a tracking of the events occurring on the online system 160. In some embodiments, the tracking module 225 assigns a tracking identifier to a tracked event on the online campaign. For example, the tracking identifier may represent a four-bit binary value with the most-significant bit (MSB) corresponding to the tracking operation. A tracking identifier of the form ‘1000’ indicates that the tracking module 225 has tracked the event as occurred during the online campaign as the MSB has an assigned value of ‘1’. In another example, the tracking identifier may involve a different configuration (e.g. 1-bit or 2-bits) for the binary value. In alternate embodiments, the tracking module 225 may not include the tracking identifier.

In some embodiments, the tracking module 225 tracks the actions of the users performed on a web page associated with the network 140. For example, the actions tracked may represent a browsing, a registration, a check-out, and a web page visit. The tracking module 225 may add a snippet of code (e.g. conversion tracking pixel) to the HTML on the web page associated with the network 140. The tracking module 225 generates a report on the number and type of conversions performed by the users on the web page. The tracking module 225 may also add a snippet of code to the HTML on the web page associated with the network 140 by measuring the number of click-throughs performed by its users. The click-throughs represent the process of a visitor clicking on a content item from the content provider 130 and going to the web page of the content provider 130. The number of click-throughs measures the amount of times a content item is clicked when the web page associated with the content item is viewed by the user.

The fraud detector 230 detects and removes one or more fraudulent events from the online events tracked by the tracking module 225. The fraud detector 230 also creates non-fraudulent events by removing the fraudulent events from the online events tracked by the tracking module 225. For example, a fraudulent event in the campaign may represent a user-click or an impression that creates a bias in accurately measuring the performance of the online campaign from the content provider 130. In some embodiments, the fraud detector 230 assigns a value of ‘1’ to the digit to the right of the MSB in the tracking identifier received from the tracking module 225. For example, a tracking identifier of the form ‘1100’ indicates that the tracked event is a fraudulent event as the first digit from the MSB has a value of ‘1’. A fraudulent event might occur when a content provider or a publisher reports that a user clicked on a content item or took an action associated with a content item (e.g., a conversion, such as a purchase of a product), which is not a real action taken by user so should not be included in a report on the performance of the content item. If one online system is better be able to detect fraudulent events than another, this can result in biased reporting that favors the latter system in that the latter system reports more events and thus more success with the online campaign on that system's platform (even though some of the events were actually fraudulent).

The view module 235 detects events that are not viewed by users of the online system 150 in the online campaign. For example, the view module 235 detects events not meeting a threshold value of time for being viewed (e.g. time of impression of an online advertisement) by users of the online system 150. In some configurations, the online system 150 maintains an internal database corresponding to the threshold value of time for being viewed for each of the third-party system 160. The events detected by the view module 235 may represent the events corresponding to impressions that are not visible to users of the online system 150. In some embodiments, the view module 235 assigns a value of ‘1’ to the second digit from the MSB in the tracking identifier received from the fraud detector 230. For example, a tracking identifier of the form ‘1110’ indicates that the tracked event is a non-viewable event as the second digit from the MSB has a value of ‘1’. In the same example, the tracked event is also a fraudulent event as the first digit from the MSB has a value of ‘1’. Determining viewable events is relevant in that accurate reporting of the number of impressions by users for a content item should not include impressions that were below the fold or where it was otherwise not possible that that the user could have actually seen the content item. If one online system is better at reporting only viewable impressions than another, this can result in biased reporting in that the latter system incorrectly reports more success in obtaining impressions in the campaign (even though fore some of the impressions reported the content item was not actually viewable).

The identity module 240 detects events for which the users are identifiable to the online system 150 in the online campaign. In some embodiments, the identity module 240 detects events as non-identifiable based on the tracked events not meeting a threshold for being recognized as actions performed by users of the online system 150. For example, the non-identifiable events represent events corresponding to user actions where the cross-device identity coverage from the client device 120 is incomplete. In some embodiments, the identity module 240 uses a device graph with information about cross-device identity coverage. The device graph representing the cross-device identity coverage may be based on deterministic and probabilistic interferences of the identifying information received from the client device 120. The device graph may have incomplete identity coverage when the identifying information associated with the users stored in the user profile store 205 is not continuously available for some of the third-party systems 160. In some embodiments, the identity module 240 assigns a value of ‘1’ to the third digit from the MSB in the tracking identifier received from the view module 235. For example, a tracking identifier of the form ‘1111’ indicates that the tracked event is a non-identifiable event as the third digit from the MSB has a value of ‘1’. In the same example, the tracked event is also a fraudulent event as the first digit from the MSB has a value of ‘1’. In addition, the tracked event is also a non-viewable event as the second digit from the MSB has a value of ‘1’. Determining whether a user who performed the event on the content item was identifiable or was able to be tied to the user's actual identity is relevant in that some systems may be especially able to identify users, even users who are not currently logged on to the system. This may result in biased reporting in favor of those systems where the system is able to determine the identity of the user performing an action associated with a content item even though other systems may actually have better performance but some of this is not tracked due to the system's more limited ability to detect identity of its users performing actions.

The measurable event module 245 removes the non-measurable events from the non-fraudulent events associated with the tracking module 225 and created by the fraud detector 230, e.g., those events not viewable by view module 235, or not identifiable by identity module 240. In some embodiments, the measurable event module 245 removes the events associated with a tracking identifier of the form ‘1111’ which indicated that the events are detected as fraudulent events, non-viewable events, and non-identifiable events. The measurable event module 245 performs the removal of non-measurable events resulting in a set of measurable events stored in the measurable store 250. In some embodiments, the set of measurable events stored in the measurable store 250 may have a tracking identifier of the form ‘1000’ based on the values assigned by the tracking module 225, the fraud detector 230, the view module 235, and the identity module 240.

The training module 255 performs a modeling on a subset of the measurable events stored in the measurable store 250. The training module 255 generates models based on the modeling operation performed on the measurable events. In some embodiments, the training module 255 performs a comparison of the tracking identifier of the generated models with the tracking identifier of the measurable events used for the modeling. The training module 255 reiterates the modeling operation until the comparison results in an identical tracking identifier indicating that the generated models represent a subset of the measurable events used for the modeling.

In some embodiments, the training module 255 may include a machine-learning component that can perform the modeling operation on the third-party system 160 by implementing a machine-learning model associated with the online system 150. For example, the training module 255 can determine the subset of the measurable events used for the modeling based on a set of feature vectors associated with the third-party system 160.

The training module 255 communicates with the tracking module 225 to determine the subset of the measurable events used for the modeling based on the number and type of click-throughs associated with some of the users of the online system 150. In alternate embodiments, the training module 255 communicates with the tracking module 225 to determine the subset of the measurable events used for the modeling based on the number of tracking conversions associated with some of the users of the online system 150.

The extrapolator 260 performs an extrapolation process on a set of measurable events using the models generated by the training module 255. The extrapolator 260 determines the set of measurable events used for the extrapolation based on a communication with the tracking module 225. In some embodiments, the extrapolator 260 performs a panel-based extrapolation of the set of measurable events using the models. Panel-based extrapolation relates to the use of an overlapped observation from a panel and the online system 150 to compare the difference, and calibrate the model from the online system 150 to be aligned with panel observations. The extrapolator 260 determines a number of valid events based on the extrapolation process. In some embodiments, the extrapolator 260 extrapolates until the emulated number matches with a pre-determined number of valid events identified by the online system 150.

The web server 265 links the online system 150 via the network 140 to the one or more client devices 120, as well as to the third-party system 160. The web server 265 serves web pages, as well as other content, such as JAVA®, FLASH®, XML and so forth. The web server 265 may receive and route messages between the online system 150 and the client device 120, for example, instant messages, queued messages (e.g., email), text messages, short message service (SMS) messages, or messages sent using any other suitable messaging technique. A user may send a request to the web server 265 to upload information (e.g., images or videos) that are stored in the object store 210. Additionally, the web server 265 may provide application programming interface (API) functionality to send data directly to native client device operating systems, such as IOS®, ANDROID™, WEBOS® or BlackberryOS.

### Process

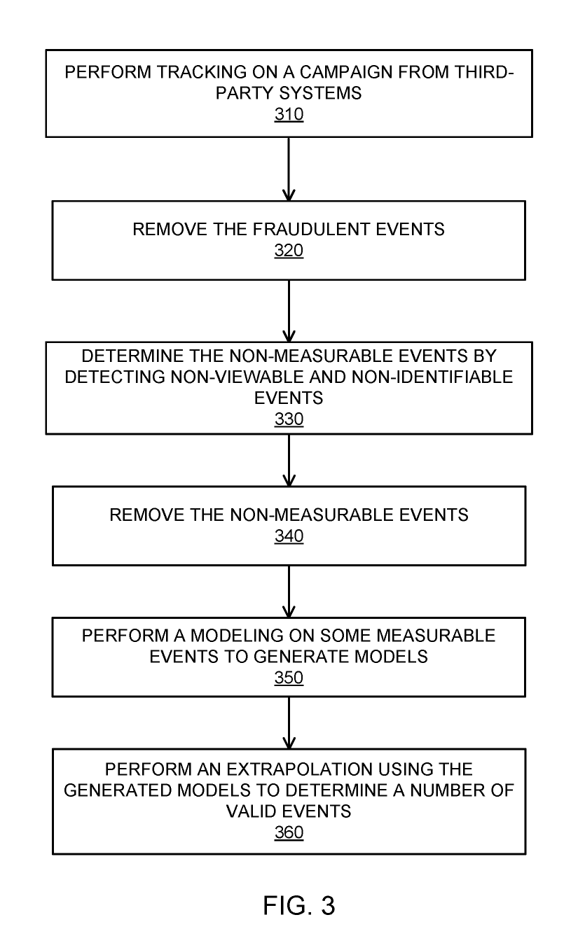

FIG. 3 is a flowchart of a process 300 for cross-publisher measurement of an online campaign, in accordance with an embodiment.

The online system 150 performs 310 tracking operations on online events corresponding to an online campaign from the third-party system 160. For example, the tracking module 225 of FIG. 2 performs the tracking operations based on the user's actions according to an embodiment. The tracking module 225 may assign a tracking identifier to a tracked event on the online campaign, track the actions of the users performed on a web page associated with the network 140, and generate a report on the number and type of conversions performed by the users on the web page.

The online system 150 removes 320 the fraudulent events using the fraud detector 230. A fraudulent event in the campaign may represent a user-click or an impression that creates a bias in accurately measuring the performance of the online campaign from the content provider 130, and thus should not be considered in the measurable events.

The online system 150 determines 330 the non-measurable events from the online events tracked by detecting non-viewable events, and non-identifiable events, for example, the view module 235, and the identity module 245. Events that are not viewable by users of the online system 150 likewise should be excluded from the measurable events. Non-identifiable events are excluded for similar reasons.

The online system 150 removes 340 the determined non-measurable events from the online events, e.g., using the measurable event module 245. For example, the removed 340 events include those events not viewable by view module 235, or not identifiable by identity module 240. The removal 340 results in a set of measurable events.

The online system 150 performs a modeling 350, e.g., using training module 255, based on at least a subset of the obtained measurable events to generate models representing a subset of the set of measurable events. In some instances, the modeling 350 includes machine-learning.

The online system 150 performs an extrapolation 360, e.g., using extrapolator 260, on the set of measurable events using the generated models to determine a number of valid events. The extrapolation 360 determines a number of valid events. In some embodiments, the number of valid events represents the number of non-measurable events that are extrapolated from the measurable portion of the campaign after removing the fraudulent events. The extrapolation 360 provides a broader measurement for the campaign that includes impressions for which identify coverage is incomplete and for which viewability is not available (but excluding fraudulent events), to provide a full, unbiased measurement for the campaign as a whole across various publishers, regardless of whether they account for viewability, have identity coverage, or detect fraud.

### Example Cross-Publisher Measurement

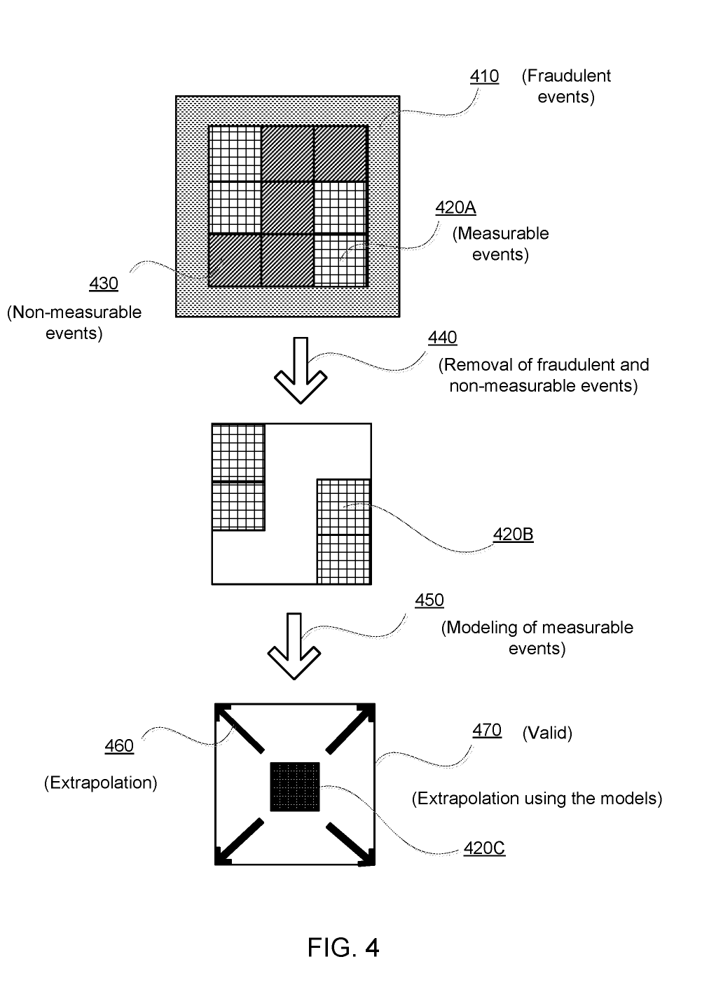

FIG. 4 is a conceptual diagram of a modeling 400 performed in cross-publisher measurement, in accordance with an embodiment. The conceptual diagram of the modeling 400 shows the tracked events of the online campaign including the fraudulent events 410 detected by the fraud detector 230, the measurable events 420A stored in the measurable store 250, and the non-measurable events 430 further comprising the non-viewable events detected by the view module 235, and the non-identifiable events detected by the identity module 240.

As described above with reference to FIGS. 2-3, the measurable event module 245 removes 440 the fraudulent events and non-measurable events from the tracked events resulting in a set of measurable events 420B separated from the fraudulent events 410 and the non-measurable events 430. The training module 255 of FIG. 2 performs 450 a modeling on at least some of the set of measurable events 420B to generate a model 420C. The model 420C generated represents a subset of the set of measurable events 420B. The extrapolator 260 performs 460 an extrapolation process using the model 420C to determine a number of valid events 470. In some embodiments, the extrapolator 260 reiterates the extrapolation process until the model 420C emulates the number of valid events pre-determined by the online system 150. For example, the online system 150 may set the number of valid events as one million. In this example, there are one million valid events representing the number of non-measurable events that are extrapolated from the measurable portion of the campaign after removing the fraudulent events. The extrapolator 260 stops reiterating the extrapolation process when the model 420C represents one million valid events.

### SUMMARY

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
performing one or more tracking operations on a campaign in an online system from one or more third-party systems, the one or more tracking operations associated with a plurality of online events and based on one or more actions of one or more users of the online system;
removing one or more fraudulent events from the plurality of online events to create a plurality of non-fraudulent events;
determining, by the online system, one or more non-measurable events of the plurality of non-fraudulent events, comprising:
detecting one or more non-viewable events from the campaign, the non-viewable events not viewed by users of the online system; and
detecting one or more non-identifiable events from the campaign;
removing the one or more non-measurable events from the plurality of online events, resulting in a set of measurable events;
performing a modeling on at least some of the set of measurable events, the modeling process generating one or more models, the one or more models representing a subset of the set of measurable events; and
performing an extrapolation process on the set of measurable events using the one or more generated models to determine a number of valid events.

2. The method of claim 1, wherein the extrapolation process is based on a number of tracking conversions associated with the online system, the number determining the set of measurable events used for the modeling.

3. The method of claim 1, wherein the extrapolation process is based on a total number of click-throughs associated with the online system, the number determining the set of measurable events used for the modeling.

4. The method of claim 1, wherein the extrapolation process is trained on the one or more third-party systems based on a machine-learning model associated with the online system.

5. The method of claim 4, wherein the machine-learning model can be implemented on the one or more third-party systems.

6. The method of claim 1, wherein the modeling is based on a measurement of one or more users associated with the online system.

7. The method of claim 1, wherein determining one or more non-measurable events is based on a number of click-throughs associated with at least one of the users of the online system.

8. The method of claim 1, wherein determining one or more non-measurable events is based on an average click-through rate associated with at least one of the users of the online system.

9. The method of claim 1, wherein the online system performs the one or more tracking operations responsive to a request to run the campaign from one or more third-party systems.

10. A computer program product comprising a non-transitory computer readable storage medium having instructions encoded therein that, when executed by a processor, cause the processor to:
perform one or more tracking operations on a campaign in an online system from one or more third-party systems, the one or more tracking operations associated with a plurality of online events and based on one or more actions of one or more users of the online system;
remove one or more fraudulent events from the plurality of online events to create a plurality of non-fraudulent events;
determine, by the online system, one or more non-measurable events of the plurality of non-fraudulent events, comprising:
detect one or more non-viewable events from the campaign, the non-viewable events not viewed by users of the online system;
detect one or more non-identifiable events from the campaign;
remove the one or more non-measurable events from the plurality of online events, resulting in a set of measurable events;
perform a modeling on at least some of the set of measurable events, the modeling process generating one or more models, the one or more models representing a subset of the set of measurable events; and
perform an extrapolation process on the set of measurable events using the one or more generated models to determine a number of valid events.

11. The computer program product of claim 10, wherein the extrapolation process is based on a number of tracking conversions associated with the online system, the number determining the set of measurable events used for the modeling.

12. The computer program product of claim 10, wherein the extrapolation process is based on a total number of click-throughs associated with the online system, the number determining the set of measurable events used for the modeling.

13. The computer program product of claim 10, wherein the extrapolation process is trained on the one or more third-party systems based on a machine-learning model associated with the online system.

14. The computer program product of claim 13, wherein the machine-learning model can be implemented on the one or more third-party systems.

15. The computer program product of claim 10, wherein the modeling is based on a measurement of one or more users associated with the online system.

16. The computer program product of claim 10, wherein determining one or more non-measurable events is based on a number of click-throughs associated with at least one of the users of the online system.

17. The computer program product of claim 10, wherein determining one or more non-measurable events is based on an average click-through rate associated with at least one of the users of the online system.

18. The computer program product of claim 10, wherein the online system performs the one or more tracking operations responsive to a request to run the campaign from one or more third-party systems.
